(19) United States
(12) Patent Application Publication
(10) Pub. No.: US 2010/0204835 A1
(43) Pub. Date: Aug. 12, 2010

(54) Device and Method to Dehumidify and to Pressurize Spaces to Pressure Below Atmospheric Pressure

(75) Inventor: Rikard Bergsten, Goteborg (SE)

Correspondence Address: POTOMAC PATENT GROUP PLLC, P. O. BOX 270, FREDERICKSBURG, VA, 22404, US

(73) Assignee: LINDENSTONE INNOVATION AB, Goteborg (SE)

(21) Appl. No.: 12/678,151

(22) PCT Filed: Sep. 18, 2008
(86) PCT No.: PCT/SE08/51045

§ 371 Date: Mar. 14, 2010

(30) Foreign Application Priority Data
Sep. 18, 2007 (SE) 0702095-1

(51) Int. Cl. G05B 15/00; G05D 22/02

(52) U.S. Cl. 700/276; 236/44 C

(57) ABSTRACT

The invention relates to a method and a device in order to protect spaces against moisture damage, based on adaptively controlled ventilation so that the ventilation is maximized when the vapour content of the supply air is lower than in the space. Simultaneously, surrounding building spaces are protected from harmful consequences of earlier moisture damage or of ground emissions of, e.g., radon gas or methane gas, by the fact that ventilation is arranged so that a minimum pressure drop always is present between the surrounding spaces and the protected space, which prevents gases and aerosols from being spread to surrounding occupation spaces. A feasible device based on the method utilizes temperature differences between the spaces in order to always make sure that an air current travels in the direction inward toward the protected space; by measuring—or in certain cases assuming—a temperature difference between the spaces, as well as measuring the temperature of the air in an arranged duct between the protected space and the surrounding spaces, the control system can determine direction of flow and approximate flow rate. The direction of flow of the air also corresponds with the direction of the pressure drop.

The present invention relates to a device in order to protect a space in a building against moisture damage as well as prevent that gases, microbes and particles arising or passing there are spread to surrounding occupation spaces in the building.

Moisture damage depending on too high relative air moisture is today usually occurring in heated as well as unheated spaces. Usual moisture damage comprises mould and rot fungus attacks, nasty-smelling bacteria, deformed material or material loosing strength. Moisture damage occurs in new as well as older buildings. Already arisen damage often leads to unhealthy air for the human being. In many spaces, also harmful gases pass or are generated such as, e.g., ground radon or methane gas in a suspended foundation or radon from building materials in, e.g., a lift/elevation shaft or ventilation shaft. Harmful emissions from chemically treated building materials are also found. Common to these problems is that, on one hand, it is desired to keep the relative air moisture low since a high ditto may lead to new or aggravated damage and, on the other hand, it is desired to retain the harmful air in the space so that it is not evacuated into surrounding occupation surfaces in a building. Previously, a so-called sorption dehumidifier has usually been used—a moisture absorbent that has been dried by means of hot air that the inside air then get to pass—in order to dehumidify the air as well as create a pressure below atmospheric pressure (a pressure drop). Occasionally, the pressure below atmospheric pressure has been possible to be adjusted in so that the rotational speed of the fan is adapted upon the occasion of installation by measuring the air pressure drop and adjust the rotational speed until desired pressure drop has been attained. The disadvantage of that method has been that, among other things, the force and the direction of the wind influence the pressure drop, which has led to the pressure drop not having been possible to be held at a minimum. It is also known that it is possible to minimize the pressure drop by measuring the air pressure on both sides of the separating surface. However, it is relatively expensive to measure air-pressure, and therefore it has not been generally occurring in practice. It has neither been suitable to make that type of installations as a fixed installation in the house since they have required maintenance and running calibration of the sensors.

It is previously known that it is possible to dry a space by only outdoor air ventilating when the vapour content outside is lower than inside. Since previously it is also known that it is possible to minimize an air pressure below atmospheric pressure by measuring the pressure in the occupation space and in the protected building space instantaneously. However, methods as well as devices are lacking, which enable the drying up from ventilation controlled on vapour content difference at the same time as a small pressure below atmospheric pressure always is retained so that maximum security for occupants of the occupation space is attained combined with minimal energy consumption. It is neither previously known that it is possible to measure the air flow through an arranged duct—and thereby indirectly the pressure difference—by measuring temperature differences on the inside, outside and in the air current in building spaces where the temperatures normally differ (e.g., a cold suspended foundation and a heated living space thereabove).

In many building spaces, the temperature fluctuations are great and hygroscopic materials store and empty themselves of moisture as temperature and air moisture fluctuates. The current established method for dehumidification and renovation using pressure below atmospheric pressure by means of a so-called sorption dehumidifier utilizes these natural fluctuations badly.

A device is since previously known in order to prevent moisture-related problems in a building space, in which one sensor outside the space measures temperature and relative moisture or vapour content, one sensor inside the space measures temperature and relative moisture or vapour content, and a controlled ventilation is opened and/or is forced when the air outside the space contains less moisture than the air in the space.

Furthermore, a device is since previously known in order to prevent moisture-related problems in a building space, in which a sensor measures temperature and air moisture and a control system stores and compares these values with the presumptions for the emergence of moisture damage in respect of growth of mould, rot fungus or soil bacteria as well as deformation of building materials; the control system activates a heating device when the climate is such that the risk of moisture damage begins to approach.

By the present invention, a device is provided, which by measuring, calculating and comparing vapour content indoors and outdoors determines if it is favourable with maximum ventilation or if it instead is suitable to minimize the ventilation in view of the need of an air flow in the direction from the occupation surfaces into the protected space. It should be emphasized that also maximum ventilation will provide a pressure difference between the protected building space and the surrounding occupation spaces if fan power, seal and size of supply air valves are correctly dimensioned.

By means of the device according to the invention it is possible to measure pressure difference or air flow and air flow direction when one of this according to known formulae can be converted to the other, and reversed. If we, e.g., assume that the arranged duct is a circular cylinder in this case (Fundamentals of fluid mechanics, Munson et al), the pressure difference between laminar and turbulent flow is

Δp=f*I*ρ*V²/(D*2)

where the friction factor f differs between the laminar and turbulent case, respectively. V is the flow rate, ρis the density, I & D are the dimensions of the arranged duct.

In warmer climates than in Sweden and in those cases the problematic gases or the particles come from subjacent ground, it may also be desirable to create a minimum positive pressure in the protected space in relation to the earth pressure (and here by earth pressure reference is made to the pressure in air pockets in subjacent ground). The latter prevents gases and particles from leaving the ground and entering into the protected building space. The method can accordingly also be used for creating a minimum positive pressure in relation to the earth pressure instead of a minimum pressure below atmospheric pressure in relation to the surrounding occupation spaces.

The protected building space can also be provided with a system, which supplies heat when a real risk of moisture damage begins to approach in view of current and historical relative moisture as well as current and historical temperature. (This is a known technique, which previously is patent pending in SE0602058-0).

The supplied heat lowers the relative air moisture in the space and decreases thereby the amount of moisture, which is supplied to the hygroscopic materials in the space; the heat also increases the ability of the air to carry moisture and therefore enables a drying up of the hygroscopic materials in the space.

Furthermore, the space may be sealed so that no or only a little non-controlled ventilation is present. Furthermore, the space may be provided with non-return valves so that wind cannot force ventilation on the system when it is undesired. Furthermore, the space may be provided with motorized valves which are opened when the vapour content outside is lower than inside.

The invention is not limited to the shown and described embodiments, but can be varied in several ways within the scope of the appended claims. It is possible to measure the air flow in other ways, e.g., by means of an impeller in a duct or by means of a valve that can be pressed up by the air flow in the direction inward toward the protected space and where the valve position can be registered (and the opposite when a positive pressure is desired). It is also possible to measure the air pressure on both sides of a separating surface.

Different methods to supplement and control, respectively, the ventilation to the protected building space are also possible, e.g., by means of one or more motorized valves. It is also possible to achieve reasonably good results by combining the system to achieve minimum pressure below atmospheric pressure with ventilation controlled only by the temperature difference between the protected building space and the surroundings, so that it ventilates maximally only when the temperature of the surroundings is lower or much lower than of the space (under the assumption that the quantity of moisture then most often is lower in the ambient air than in the space).

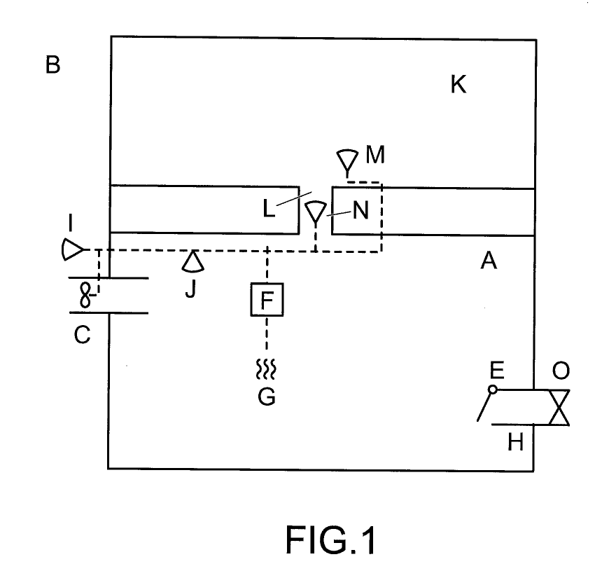

The invention will in the following be described, reference being made to embodiment example shown in the accompanying FIG. 1.

A control, measuring and regulating system (F) measures by means of a sensor (J) temperature and relative air moisture or vapour content in a protected building space (A) and, by means of a sensor (I), temperature and/or relative air moisture or vapour content in a supply air space in (B). If the vapour content in (B) is equal to or lower than the one in (A), the control system (F) will maximize the ventilation by maximizing the rotational speed of a fan (C) and by opening a controlled valve (O) that for providing maximum effect is provided to the system. If such opportunities do not prevail, i.e., when the vapour content in (B) is higher than in (A), the control system (F) measures the temperature in an occupation space (K) and an arranged air-duct (L) by means of sensors (M) and (N), respectively, and controls the rotational speed of the fan (C) so that the temperature in (L) is lying substantially closer to the temperature in (K) than the temperature in (A) as measured by sensor (J) but is not equal to the temperature in (K), as well as shuts off possible valve (O). The desired temperature difference between (L) and (K) can be set in the control system as either an absolute difference or as a share of the temperature difference between (K) and (A). Alternatively, the system assumes that the temperature in (K) is room temperature and only measures the temperature in (A) by sensor (J) and in (L) by sensor (N), respectively, in this respect (the temperature is also measured in (B) by sensor (J) as a part of determining the vapour content). The placement of the sensor (N) in the duct (L) should be carried out so that it is significantly closer to the protected building space (A) than the space (K) in order to facilitate for the system to differentiate between sufficient ventilation and too much ventilation for cases when the ventilation is unfavourable, i.e., when the vapour content of the supply air (B) is higher than in (A). A possible embodiment is to let the duct extend a small bit into the protected space (A) and place the sensor (N) in this part of the duct. One or more valves (H) enable throughput of air through the space. A possible non-return valve (E) prevents wind from forcing forward an undesired ventilation of the space (A) by (H). In an alternative embodiment, one or more controlled valves (O) may be opened when the vapour content outside is lower than inside. The valve or the valves H have to be dimensioned so that a suitable flow resistance is attained in view of the smallest pressure difference between the protected space (A) and the occupation surface (K) that the system is set to drive forward.

In an alternative embodiment, the control system (F) activates a heating device (G) if temperature and relative air moisture or moisture ratio in (A) are such, in the moment of measuring as well as earlier, that there may be risk of growth of mould fungus, rot fungus or nasty-smelling bacteria or that there otherwise is risk of deformation or weakening of the material in (A).

1.-9. (canceled)

10. A device to prevent moisture-related problems in a protected building space and prevent transportation of harmful substances to surrounding occupation spaces by holding the protected building space at a pressure below atmospheric pressure in relation to the surrounding occupation spaces by removing air from the protected space and supplying air to the protected building space from a supply air space, the device comprising:
a first sensor in the supply air space configured to measure at least one of temperature, relative moisture, and vapor content in supply air;
a second sensor in the protected building space configured to measure at least one of temperature, relative moisture, and vapor content in the protected building space; and
a control system and at least one third sensor configured to measure at least one of pressure difference and air flow and to measure air flow direction between the protected building space and at least one of the surrounding occupation spaces;
wherein the control system is further configured to remove, when the vapor content of the supply air is greater than the vapor content of air in the protected building space, only so much ventilation air that a pressure drop or an air flow arises in at least one duct between the occupation spaces and the protected building space, and to ventilate, when the vapor content of air in the protected building space is greater than or equal to the vapor content of air in the supply air space, the protected building space to dry the protected building space substantially as much as possible.

11. The device of claim 10, wherein a third sensor is placed in at least one of the surrounding occupation spaces and is configured to measure temperature, and another third sensor is placed in at least one duct between the protected building space and surrounding occupation spaces and is configured to measure temperature of air in the at least one duct.

12. The device of claim 11, further comprising at least one variable-speed controlled fan, wherein the control system comprises a comparator configured to compare the vapor content in the supply air space with the vapor content in the protected building space; when the vapor content in the supply air is less than or equal to the vapor content in the protected building space, the control system substantially maximizes rotational speed of the at least one fan; and when the vapor content in the supply air is greater than the vapor content in the protected building space, the control system aims for a smallest feasible ventilation by lowering rotational speed of the at least one fan so that the temperature in the at least one duct falls and is substantially closer to the temperature in the surrounding occupation spaces than to the temperature in the protected building space.

13. The device of claim 12, further comprising at least one motorized valve, wherein the control system comprises a comparator configured to compare the vapor content in the supply air space with the vapor content in the protected building space; when the vapor content of the supply air is less than or equal to the vapor content in the protected building space, the control system substantially maximizes rotational speed of the at least one fan and opens the at least one motorized valve; and when the vapor content in the supply air is greater than the vapor content in the protected building space, the control system aims for the smallest feasible ventilation by lowering rotational speed of the at least one fan and closing all motorized valves so that the temperature in the at least one duct falls and is substantially closer to the temperature in the surrounding occupation spaces than to the temperature in the protected building space.

14. The device of claim 13, further comprising at least two pressure sensors placed in the protected building space and in the surrounding occupation spaces, respectively; wherein the control system compares the vapor content in the supply air space with the vapor content in the protected building space; when the vapor content in the supply air is less than or equal to the vapor content in the protected building space, the control system substantially maximizes rotational speed of the at least one fan and opens the at least one motorized valve; and when the vapor content in the supply air is greater than the vapor content in the protected building space, the control system aims for the smallest feasible ventilation by lowering rotational speed of the at least one fan and by closing the at least one motorized valve so that a pressure drop into the protected building space is positive and near zero.

15. The device of claim 10, further comprising a gauge of air flow and air flow direction, wherein the gauge is placed in the at least one duct between the protected building space and the surrounding occupation spaces.

16. The device of claim 10, further comprising a sensor in the protected building that is configured to measure temperature and relative moisture, vapor content, or moisture ratio; and a controlled heating assembly configured controllably to heat air in the protected building space when there is risk of moisture damage based on an indication of at least one of current and possible historical temperature and current and possible historical relative moisture.

17. A method to prevent moisture-related problems in a protected building space by forced ventilation from a supply air space to the protected building space and to prevent spread of harmful substances from the protected building space to at least one surrounding occupation space, comprising:
measuring and comparing vapor contents in the supply air space and in the protected building space;
measuring and comparing a difference in air pressure or air flow and air flow direction between a surrounding occupation space and the protected building space;
when the vapor content in the supply air space is less than or equal to the vapor content in the protected building space, maximizing forced ventilation; and
when the vapor content in the supply air space is greater than the vapor content in the protected building space, minimizing forced ventilation;
whereby only so much ventilation is forced that a pressure below atmospheric pressure arises in the protected building space in relation to the surrounding occupation space.

18. The method of claim 17, further comprising assuming the temperature in the surrounding occupation space is equal to normally occurring room temperature, and minimizing the ventilation when the vapor content outside is higher than inside by adapting rotational speed of a fan so that a temperature in a duct between the protected building space and the surrounding occupation space is substantially closer to normally occurring room temperature than to the temperature in the protected building space.
